(19) United States
(12) Patent Application Publication
(10) Pub. No.: US 2007/0158465 A1
(43) Pub. Date: Jul. 12, 2007

(54) METHODS FOR REMOVING SAND OR DEBRIS FROM A PERSON USING A SPRAYER

(76) Inventor: Frederick G. Ingraham, Danvers, MA (US)

Correspondence Address: ANTOINETTE G. GIUGLIANO, P.C., 100 Cummings Center, Suite 342G, Beverly, MA, 01915, US

(21) Appl. No.: 11/306,676

(22) Filed: Jan. 6, 2006

(51) Int. Cl. B05B 9/04; B08B 3/00; B05B 15/06

(52) U.S. Cl. 239/373; 239/532; 134/34

(57) ABSTRACT

The present invention includes devices, apparatus, systems and methods for removing sand or debris on a person. The spray device has an essentially spherically shaped pressure vessel for storing water wherein the vessel has a volume in a range between about a ½ gallon and about 3 gallons; a hand pump connected to the spherically shaped pressure vessel; a bulkhead fitting having an interior end and an exterior end wherein the fitting is on the spherically shaped pressure vessel and defines an opening in the wall of the pressure vessel for flow of the water; a tube that extends from the interior end of the bulkhead fitting to the bottom of the spherically shaped pressure vessel; a flexible hose having a first end and second end, wherein the first end is connected to the exterior end of the bulkhead fitting; a spray handle having a first end and a second end; wherein the first end is connected to the second end of the hose; a handle trigger mounted to the body of the spray handle; a discharge control valve mounted to the second end of the spray handle; and a spray nozzle connected to the discharge control valve. The methods of the present invention include spraying sand or debris off of a person using this device. The present invention further includes sand sprayer kits.

### RELATED APPLICATION

This application relates to a Design Application of U.S. application Ser. No. (not yet provided; Attorney Docket No.: 0030.0002-000) filed on an even date herewith.

The entire teachings of the above application are incorporated herein by reference.

### BACKGROUND OF THE INVENTION

Kids who play at a beach or a park often leave with sand or dirt stuck to their body or bathing suits. Cleaning the sand off kids with towels or a bucket of water many times is not an effective way to remove the sand. Many beaches and/or parks have limited or no access to showers or running water. As a result, children often track sand in the vehicle and/or into their home leaving parents to clean up the sand.

A need exists for a cleaning system that removes the majority or most of sand from a person or child. A further need exists to do so in a manner that is easy and effective.

### SUMMARY OF THE INVENTION

The present invention relates to device, apparatus, and methods for removing sand or debris on a person by spraying water at the sand or debris on the person with a specially designed spray device. The spray device (e.g., apparatus) has an essentially spherically shaped pressure vessel for storing water wherein the vessel has a volume in a range between about a ½ gallon and about 3 gallons. The spray device also has a hand pump connected to the spherically shaped pressure vessel; a fitting (e.g., bulkhead fitting) having an interior end and an exterior end wherein the fitting is on the spherically shaped pressure vessel and defines an opening in the wall of the pressure vessel for flow of the water; a tube that extends from the interior end of the fitting to the bottom of the spherically shaped pressure vessel; a flexible hose having a first end and second end, wherein the first end is connected to the exterior end of the fitting; a spray handle having a first end and a second end; wherein the first end is connected to the second end of the hose. The device further includes a handle trigger mounted to the body of the spray handle; a discharge control valve mounted to the second end of the spray handle; and a spray nozzle connected to the discharge control valve. The present invention also pertains to a system that includes the device and water in an amount ranging between about ¼ gallon and about 2½ gallons. Preferably, the water used in the system is essentially pure water, seawater, or water from a freshwater source (e.g., lake or pond water).

In particular the methods of the present invention include aiming the spray nozzle at the sand or debris on the person; and engaging the handle trigger to thereby allow water to exit the spray nozzle. The method further includes controlling or manipulating the water spray with the discharge control valve. The water sprays at a rate in a range between about 0.25 gallons/minute and about 10 gallons/minute (e.g., about 1, 2, 3, 4, 5, 6, 7, 8, or 9 gallons/minute). The user aims the spray nozzle from a distance between about 6 inches and about 4 feet (e.g., about 1, 2, or 3 feet). The methods of the present invention further include pumping a hand pump on the device more than one time, for example, about 2 to about 8 times (e.g., about 3, 4, 5, 6, or 7 times) to thereby increase air pressure in the vessel. The method also includes engaging the discharge control valve to control the water flow rate and/or water spray.

In another embodiment, the steps of method include filling the spherically shaped pressure vessel with water; pumping the hand pump on the device more than one time to thereby increase air pressure in the vessel; aiming the spray nozzle at the sand or debris on the person; and engaging the handle trigger to thereby allow water to exit the spray nozzle.

In yet another embodiment, the present invention includes a sand spraying kit that contains one or more parts described herein for assembly by a user. The parts of the sprayer include one or more of the following, or in combination: an essentially spherically shaped pressure vessel for storing water wherein the vessel has a volume in a range between about a ½ gallon and about 3 gallons; a pump connected to the spherically shaped pressure vessel; a fitting (e.g., bulkhead fitting) having an interior end and an exterior end wherein the fitting is on the spherically shaped pressure vessel and defines an opening in the wall of the pressure vessel for flow of the water; a tube that extends from the interior end of the bulkhead fitting to the bottom of the spherically shaped pressure vessel; a flexible hose having a first end and second end, wherein the first end is connected to the exterior end of the bulkhead fitting; a spray handle having a first end and a second end; wherein the first end is connected to the second end of the hose; a handle trigger mounted to the body of the spray handle; a discharge control valve mounted to the second end of the spray handle; and a spray nozzle connected to the discharge control valve. The kit can further include beach related items (e.g., a beach towel, sun screen), sand removal related items or combination thereof.

The present invention advantageously provides for an easy and effective way to remove sand from a child or person, after visiting a beach or park. The present invention allows for most, if not all, of the sand to be removed from the person's body, thereby preventing one from tracking sand into the car or home. Additionally, the spherically shaped vessel makes the device easier to clean, inside and out.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a spray device with a hand pump used in one embodiment of the present invention.

FIG. 2 is a side view of the spray device with a hand pump used in an embodiment of the present invention, wherein a portion of the side of the spray device is cut away revealing an inside view.

FIG. 3 is a perspective view showing the spray device in use.

FIG. 4 is a side view of the spray device with a motorized pump used in an embodiment of the present invention.

### DETAILED DESCRIPTION OF THE INVENTION

A description of preferred embodiments of the invention follows.

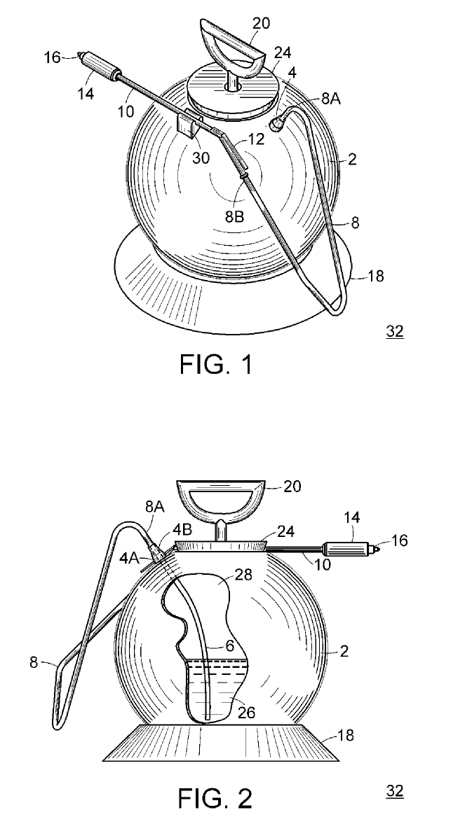

The present invention pertains to devices, apparatus, methods and kits for removing sand or debris from a person. Referring to FIG. 1, hand pump sprayer 32 has spherically shaped pressurized vessel 2 for holding water used to spray off sand or debris. In the preferred embodiment, the pressurized vessel can be essentially or substantially spherical. For example, the bottom, top, or side of the sphere can be flattened or modified a bit to accommodate the parts of the sprayer e.g., base, clip, or the cover/hand pump assembly. As such, the phrase “spherically shaped” as used herein refers to a shape that is essentially or substantially spherical, e.g., as shown in FIG. 1. The spherical shape mimics that of a ball, e.g., a beach ball, basket ball, soccer ball, etc. and can be designed to look like any type of ball. In particular, the spherically shaped pressurized vessel can comprise various designs, patterns, colors, scenes, characters, or any combination thereof. In one preferred embodiment, the spherically shaped pressurized vessel is designed in a beach ball pattern with 5 or 6 lines running from the cover to the base, evenly spaced around the sphere, creating segments that can each be colored with a particular color. In another embodiment, the pressurized vessel can have other similar shapes suitable for holding the volume of water described herein, such as an elliptical shape. The spherical or elliptical shape of the pressurized vessel is advantageous in one respect because it allows one to more easily clean the inside and/or outside of the vessel.

In an embodiment, the spherically shaped pressurized vessel is formed of a ridged material such as, for example, a molded plastic, stainless steal. Such materials are readily available in the art. In another embodiment, the spherically shaped pressurized vessel is made from an inflatable material, such as a flexible plastic material, similar to that of a beach ball. In such an embodiment, the vessel is inflated when filled with water and pressurized air, the vessel expands and takes on essentially a spherical shape. Conversely, when the device is use and water begins to exit the spray nozzle, the vessel begins to collapse.

The pressurized vessel has a volume that holds enough water to accomplish the task of washing the sand off one or more persons (e.g., between about 1 and about 5 persons), yet light enough to carry and use with one hand. In one embodiment, the spherically shaped pressurized vessel has a volume in a range between about ½ gallon and about 3 gallons (e.g., about 1, 1½, 2, or 2½ gallons) and has a working capacity of about a ¼ gallon to about 2½ gallons (about ½, 1, 1½, or 2 gallons). The working capacity is less than the total volume of the spherically shaped pressurized vessel because a portion of the volume is filled with air that is pressurized with a pump. The pressurized air forces the water to exit the vessel. The water used with this device is preferably relatively pure water (e.g., tap or well water), seawater, or water from a freshwater source (e.g., lake or pond). The water used in this device should be free of chemicals, pesticides, insecticides, or the like.

Spherically shaped pressurized vessel 2 has bulkhead fitting 4 attached to it. The bulkhead fitting has interior end 4A and an exterior end 4B. Interior end 4A attaches to tube 6, as shown in FIG. 2. Any fitting known in the art or later developed can be used to connect a tube to a hose while preventing any leakage of the water from the vessel. Gaskets, washers, or silicone can be used in conjunction with any fitting to prevent leakage. The bulkhead fitting is attached to maintain a substantially air-sealed environment in the vessel. Such fittings are commercially available.

Tube 6 extends to the bottom of the interior of spherically shaped pressurized vessel 2 to allow water to travel from the vessel up through the tube. The tube can be mounted along the inner side of the vessel or allowed to hang freely so long as the end of the tube is located in proximity to or on the bottom portion of the spherically shaped pressurized vessel.

Hand pump sprayer 32 further includes hose 8 which has first end 8A and second end 8B. First end 8A is attached to exterior end 4B of bulkhead fitting 4, and extends to spray handle 10. The spray handle is cylindrical, and can be stiff or flexible. The spay handle can be removably attached to the spherically shaped pressure vessel or to any other portion of the sprayer with clip 30. Spray handle 10 has hand trigger 12 and discharge control valve 14. The hand trigger can be any device, known or developed in the future, that is controlled by the user and allows the user to block or open the flow of water. A discharge control valve serves to control the rate of water flow and the distribution of the water spray. In one embodiment, the discharge control valve is threaded and is turned either clockwise or counter clockwise to increase or decrease the rate of water flow. The rate and pressure of water flow are sufficient to allow removal of sand from a person, but are not so strong as to cause injury to the person. The water flow rate ranges between about 0.25 gallons/minute and about 10 gallons/minute. Spray nozzle 16 is attached to discharge control valve 14.

Spherically shaped pressurized vessel 2 has an opening for receiving treaded cover 24, which in turn receives hand pump 20. Hand pump 20 is pumped up and down to create pressurized air 28 in the vessel, which pushes the water through the hose and out the nozzle. The hand pump is integrated with or affixed to the treaded cover through a neck into the pressurized vessel, and is attached or connected to maintain a substantially air-sealed environment within the pressurized vessel. Any pump that is known or later developed can be used with the spherically shaped pressurized vessel described herein, so long as the pump, when in use, can create pressurized air in the vessel.

As shown in FIGS. 1 and 2, the hand pump sprayer 32 has circular base 18. Circular base 18 is connected to or integrated with the bottom portion of spherically shaped pressurized vessel 2. The base acts to maintain the vessel upright when in use or when being stored, e.g., in a home or vehicle. In addition to a circular base, a sprayer can have feet attached to the spherical vessel or indentations integrated into the shape of the vessel. Any type of base known in the art or later developed can be used to hold the sprayer upright when in use or in storage.

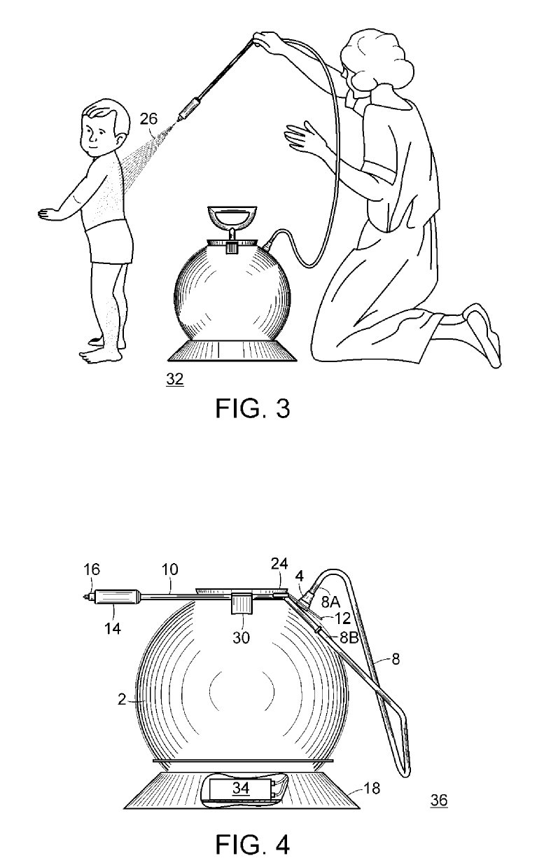

Referring now to FIG. 3, hand pump sprayer 32 is being used to carry out a method of the present invention. The method of the present invention includes spraying water at a person with sand or debris on them using the hand pump sprayer described herein. In particular, the methods included pumping hand pump 20 more than one time, e.g., between about 2 and about 8 times, and aiming spray nozzle 16 at the sand or debris on the person. The method then engaging handle trigger 12 to thereby allow water 26 to exit spray nozzle 16 and remove the sand or dirt from the person. While aiming the spray nozzle, the user can stand at a distance between about 6 inches and about 4 feet from the person having the sand or debris. In particular, the methods include pumping the hand pump to increase air pressure in the tank. Engaging the handle trigger involves depressing the trigger to allow water to exit and releasing it to cease the water flow. The method further includes engaging or turning discharge control valve 14 to control the rate and spray of the water flow. In one embodiment, as the discharge control valve is turned clockwise or counterclockwise to increase or decrease the water flow rate and modify the spray. The user can increase or decrease the water flow as desired to remove sand or debris. The water spray should be strong enough to remove the sand, but not so strong that it injures the persons being sprayed. As used in the method, the water flow rate ranges between about 0.25 gallons/minute and about 10 gallons/minute.

The methods of the present invention further include filling spherically shaped pressurized vessel 2 with water prior to use. In particular, the user can partially fill spherically shaped pressurized vessel 2 with between about a ½ gallon and 2½ gallons of water. This is accomplished by unscrewing threaded cover 24 by turning it counterclockwise until it is opened, and placing water in the vessel, and screwing threaded cover 24 by turning it clockwise until closed. The vessel is only partially filled e.g., to the “full” line, to leave room for air to be pressurized. The present invention utilizes a vessel that has a volume in a range between about ½ gallon and about 3 gallons, and is filled about a ¼ gallon and about 2½ gallons of water, e.g., its working capacity.

The present invention, in another embodiment, includes methods that involve using a device having the chamber of any shape. Using a commercially available sprayer having a water flow rate between about 0.25 gallons/minute and about 10 gallons/minute. Although many such sprayers are sold for use with garden chemicals or pesticides, they can be adapted for use with the methods described herein. Instead of placing such chemicals in the device, the user places water in the pressurized vessel. Examples of sprayers that can be adapted to perform the method include R.E. Chapin 2 Gallon Sprayer, Model No: 30203 (Chapin manufacturing, Batavia, N.Y.); and Gilmour Sprayer, Model No: 1P (Gilmour Group, Somerset, Pa.). The spray device can be made and/or assembled using the parts described herein with techniques known in the art.

As shown in FIG. 4, in another embodiment, motorized pump 34 can be used in place of a hand pump in motorized pump sprayer 36. As with the hand pump, the motorized pump can serve to push or place air in the vessel to increase the air pressure. Any motorized pump known in the art or later developed can be used so long as it can place air in the vessel to increase the air pressure in the vessel, as described herein. The motorized pump can be stored in the base, for example, or in a compartment integrated in the vessel.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of removing sand or debris on a person, the method comprises spraying water at the sand or debris on the person with a spray device that comprises:
an essentially spherically shaped pressure vessel for storing water wherein the vessel has a volume in a range between about a ½ gallon and about 3 gallons;
a hand pump connected to said spherically shaped pressure vessel;
a fitting having an interior end and an exterior end wherein the fitting is on the spherically shaped pressure vessel and defines an opening in the wall of the pressure vessel for flow of the water;
a tube that extends from the interior end of the fitting to the bottom of the spherically shaped pressure vessel;
a flexible hose having a first end and second end, wherein the first end is connected to the exterior end of the fitting;
a spray handle having a first end and a second end, wherein the first end is connected to the second end of the hose;
a handle trigger mounted to the body of the spray handle;
a discharge control valve mounted to the second end of the spray handle; and
a spray nozzle connected to the discharge control valve.

2. The method of claim 1, wherein the method includes:
aiming the spray nozzle at the sand or debris on the person; and
engaging the handle trigger to thereby allow water to exit the spray nozzle.

3. The method of claim 2, wherein water sprays at a rate in a range between about 0.25 gallons/minute and about 10 gallons/minute.

4. The method of claim 2, wherein the spray nozzle is aimed from a distance between about 6 inches and about 4 feet.

5. The method of claim 1, wherein the method further includes pumping a hand pump on the device more than one time to thereby increase air pressure in the vessel.

6. The method of claim 5, further including engaging the discharge control valve to control the water flow rate.

7. The method of claim 1 wherein the method further includes:
filling the spherically shaped pressure vessel with water;
pumping the hand pump on the device more than one time to thereby increase air pressure in the vessel;
aiming the spray nozzle at the sand or debris on the person; and
engaging the handle trigger to thereby allow water to exit the spray nozzle.

8. A sand spraying device that comprises:
an essentially spherically shaped pressure vessel for storing water wherein the vessel has a volume in a range between about a ½ gallon and about 3 gallons;
a hand pump connected to said spherically shaped pressure vessel;
a fitting having an interior end and an exterior end wherein the fitting is on the spherically shaped pressure vessel and defines an opening in the wall of the pressure vessel for flow of the water;
a tube that extends from the interior end of the fitting to the bottom of the spherically shaped pressure vessel;
a flexible hose having a first end and second end, wherein the first end is connected to the exterior end of the fitting;
a spray handle having a first end and a second end, wherein the first end is connected to the second end of the hose;
a handle trigger mounted to the body of the spray handle;
a discharge control valve mounted to the second end of the spray handle; and
a spray nozzle connected to the discharge control valve.

9. A sand spraying system that comprises:
a sand spraying device that comprises:
an essentially spherically shaped pressure vessel for storing water wherein the vessel has a volume in a range between about a ½ gallon and about 3 gallons;
a hand pump connected to said spherically shaped pressure vessel;
a bulkhead fitting having an interior end and an exterior end wherein the fitting is on the spherically shaped pressure vessel and defines an opening in the wall of the pressure vessel for flow of the water;
a tube that extends from the interior end of the bulkhead fitting to the bottom of the spherically shaped pressure vessel;
a flexible hose having a first end and second end, wherein the first end is connected to the exterior end of the bulkhead fitting;
a spray handle having a first end and a second end, wherein the first end is connected to the second end of the hose;
a handle trigger mounted to the body of the spray handle;
a discharge control valve mounted to the second end of the spray handle; and
a spray nozzle connected to the discharge control valve; and
water, in an amount ranging between about ¼ gallon and about 2½ gallons.

10. The system of claim 9, wherein the water is essentially pure.

11. A sand spraying kit having one or more parts for assembly by a user, wherein the kit comprises:
an essentially spherically shaped pressure vessel for storing water wherein the vessel has a volume in a range between about a ½ gallon and about 3 gallons;
a pump connected to said spherically shaped pressure vessel;
a bulkhead fitting having an interior end and an exterior end wherein the fitting is on the spherically shaped pressure vessel and defines an opening in the wall of the pressure vessel for flow of the water;
a tube that extends from the interior end of the bulkhead fitting to the bottom of the spherically shaped pressure vessel;
a flexible hose having a first end and second end, wherein the first end is connected to the exterior end of the bulkhead fitting;
a spray handle having a first end and a second end, wherein the first end is connected to the second end of the hose;
a handle trigger mounted to the body of the spray handle;
a discharge control valve mounted to the second end of the spray handle; and
a spray nozzle connected to the discharge control valve.

12. The kit of claim 8, further including beach related items, sand removal related items or combination thereof.
